(19) United States
(12) Patent Application Publication
(10) Pub. No.: US 2018/0075149 A1
(43) Pub. Date: Mar. 15, 2018

(54) METHODS, APPARATUS AND SYSTEMS FOR USE WITH INFORMATION-CENTRIC NETWORKING (ICN)

(71) Applicant: InterDigital Patent Holdings, Inc., Wilmington, DE (US)

(72) Inventors: Dirk Trossen, London (GB); Alexander Reznik, Pennington, NJ (US)

(21) Appl. No.: 15/565,195

(22) PCT Filed: Apr. 5, 2016
(86) PCT No.: PCT/US16/26007

§ 371 Date: Oct. 9, 2017

Related U.S. Application Data
(60) Provisional application No. 62/146,641, filed on Apr. 13, 2015.

(51) Int. Cl. G06F 17/30; H04L 29/08

(52) U.S. Cl. CPC G06F 17/30867; H04L 67/10; G06F 17/30542; H04L 67/327

(57) ABSTRACT

Methods, apparatus and systems for matching at least one publisher of content to a subscriber of the content are disclosed. A representative method may include obtaining, by a first entity from the subscriber, a content identifier associated with requested content, the content identifier being established in accordance with a first namespace; obtaining, by the first entity from a second entity, constraint information that is established in accordance with a second namespace and associated with the at least one publisher of the requested content and the subscriber of the requested content; and matching the at least one publisher of the content to the subscriber of the content based on the obtained content identifier and the obtained constraint information.

### FIELD

The present invention relates to the field of wireless communications and ICNs and, more particularly, to methods, apparatus and systems for use with information-centric networking.

### BACKGROUND

The Internet may be used to facilitate content distribution and retrieval. In existing Internet protocol (IP) networks, computing nodes are interconnected by establishing communications using IP addresses of these nodes. In ICNs, users are interested in the content itself, rather than where the content is stored. Content distribution and retrieval may be performed by ICNs based on names i.e., identifiers (IDs)) of content, rather than IP addresses.

### SUMMARY

Certain representative embodiments include methods, apparatus and systems to match at least one publisher of content to a subscriber of the content. One such representative method comprises: obtaining, by a first entity from the subscriber, a content identifier associated with the content, the content identifier being established in accordance with a first namespace; obtaining, by the first entity from a second entity, constraint information that is established in accordance with a second namespace and associated with the at least one publisher of the content; and matching the at least one publisher of the content to the subscriber of the content based on the obtained content identifier and the obtained constraint information.

Other representative embodiments include methods, apparatus and systems to manage constraints associated with a constraint namespace using a plurality of entities by establishing constraint information in accordance with a predefined constraint namespace. One such representative method comprises: subscribing, by a constraint server, to one or more publications of the constraint information provided by a respective one or respective ones of the entities; associating the constraint information provided by the respective one or ones of the entities and one or more content identifiers associated with the respective one or ones of the entities, as constraint namespace information; and publishing, by the constraint server to a rendezvous point; the constraint information.

Additional representative embodiments include methods, apparatus and systems to publish content that is associated with a content identifier. One such representative method comprises: publishing, by a publisher of the content, constraint information that corresponds to the content identifier of the content; receiving, by the publisher, a request for the content; and publishing, by the publisher, the content to the subscriber in accordance with the published constraint information.

Further representative embodiments include methods, apparatus and systems to subscribe to content that is associated with a content identifier. One such representative method comprises publishing, by a subscriber, constraint information that corresponds to the content identifier of the content; sending, by the subscriber, a request for the content including the content identifier; and receiving, by the subscriber, the content in accordance with the published constraint information.

Still additional representative embodiments include a rendezvous point (RP). One such representative RP comprises: a transmit/receive unit configured to: obtain, from a subscriber, a content identifier associated with content, and obtain constraint information that is established in accordance with a constraint namespace and associated with at least one publisher of the content; and a processor communicatively coupled to the transmit/receive unit and configured to match the at least one publisher of the content to the subscriber of the content based on the obtained content identifier and the obtained constraint information.

Still further representative embodiments include a constraint server (CS) configured to manage constraints of a plurality of entities that are associated with a constraint namespace. One such representative CS comprises: a processor and a transmit/receive unit configured to: subscribe to one or more publications of constraint information provided by a respective one or respective ones of the entities; associate the constraint information provided by the respective one or ones of the entities and one or more content identifiers associated with the respective one or ones of the entities, as constraint namespace information; and publish to a rendezvous point the constraint namespace information.

Still other representative embodiments include a publisher configured to publish content that is associated with a content identifier. One such representative publisher comprises: a processor configured to publish constraint information that corresponds to the content identifier of the content; and a transmit/receive unit configured to receive a request for the content, wherein the processor and the transmit/receive unit are configured to publish the content for a subscriber in accordance with the published constraint information.

Yet further representative embodiments include a subscriber configured to subscribe to content that is associated with a content identifier. One such representative subscriber comprises: a processor configured to publish constraint information that corresponds to the content identifier of the content; and a transmit/receive unit configured to send a request for the content, wherein the processor and the transmit/receive unit are configured to receive the content in accordance with the published constraint information.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals in the Figures indicate like elements, and wherein:

FIG. 1A is a system diagram illustrating a representative communication system in which various embodiments may be implemented;

FIG. 1B is a system diagram illustrating a representative wireless transmit/receive unit (WTRU) that may be used within the communication system illustrated in FIG. 1A;

FIG. 1C is a system diagram illustrating a representative radio access network (RAN) and a representative core network (CN) that may be used within the communication system illustrated in FIG. 1A;

FIG. 2 is a block diagram illustrating a representative ICN system;

FIG. 3 is a diagram illustrating a representative constraints namespace;

FIGS. 4-6 are diagrams illustrating various representative constraint encoding operations.

FIG. 7 is a flow chart illustrating a representative matching method;

FIG. 8 is a flow chart illustrating a representative constraint management method;

FIG. 9 is a flow chart illustrating a representative publishing method; and

FIG. 10 is a flow chart illustrating a representative subscribing method.

### DETAILED DESCRIPTION

Although the detailed description is illustrated and described herein with reference to specific embodiments, the invention is not intended to be limited to the details shown. Rather, various modifications may be made in the details within the scope and range of equivalents of the claims and without departing from the invention.

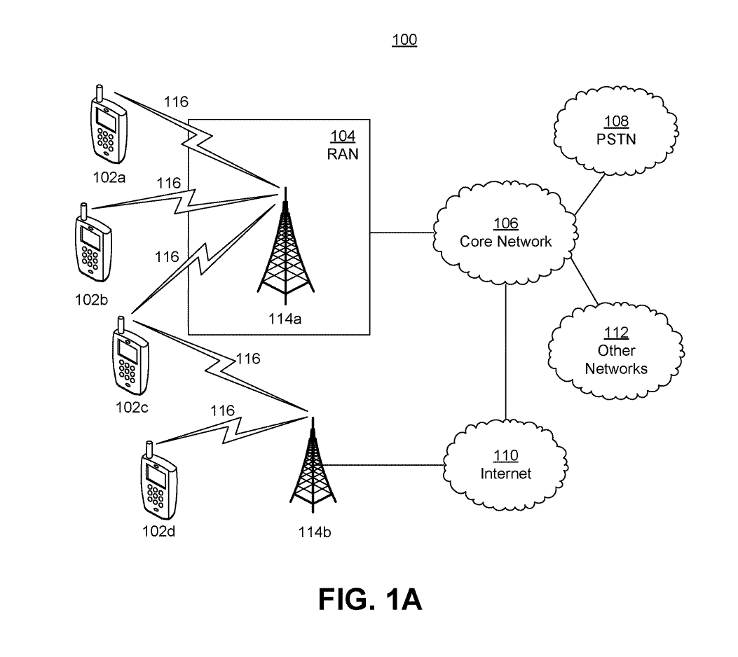

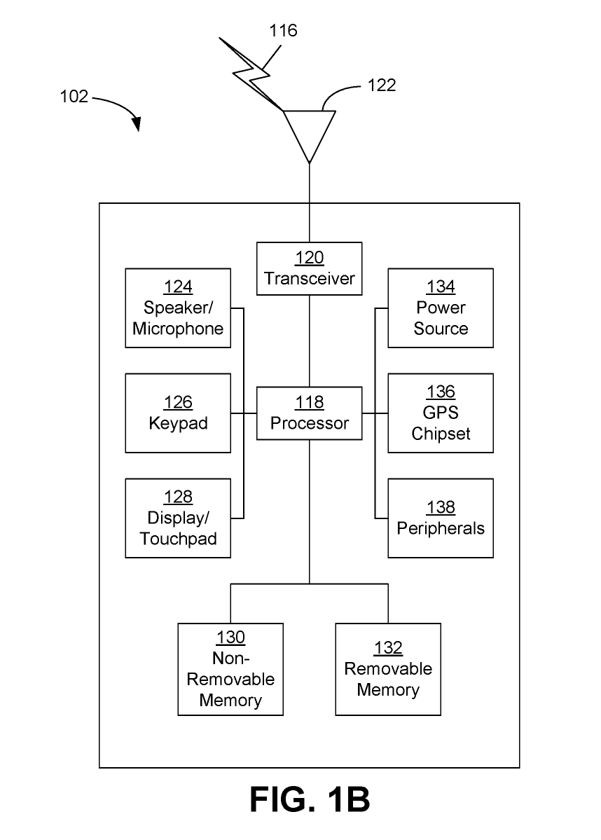

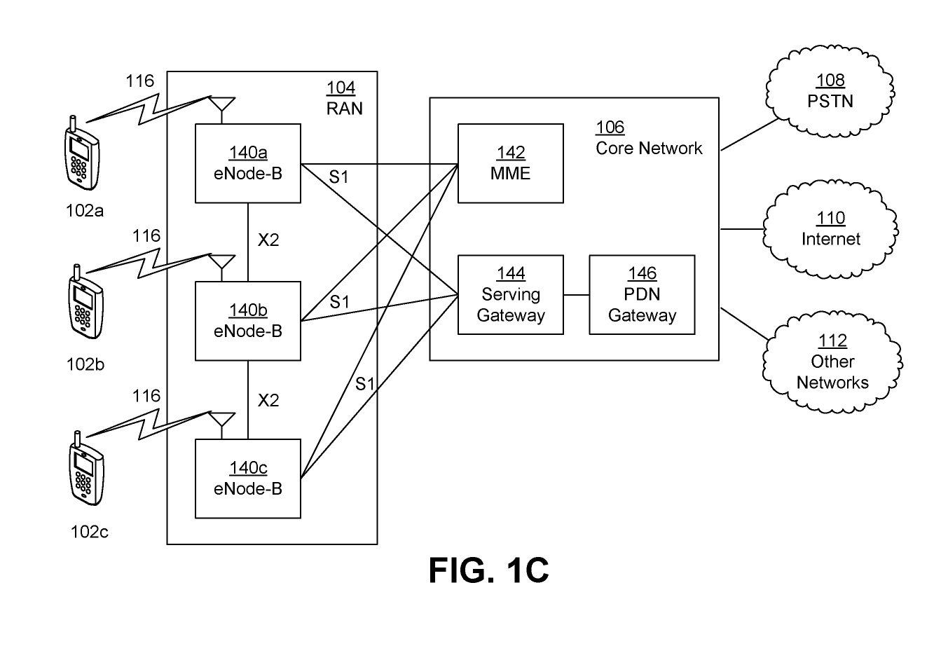

FIG. 1A is a system diagram illustrating a representative communication system 100 in which various embodiments may be implemented.

The communication system 100 may be a multiple access system that may provide content, such as voice, data, video, messaging, and/or broadcast, among others, to multiple wireless users. The communication system 100 may enable multiple wireless users to access such content through the sharing of system resources, including wireless bandwidth. For example, the communication systems 100 may use one or more channel access methods, such as code division multiple access (CDMA), time division multiple access (TDMA), frequency division multiple access (FDMA), orthogonal FDMA (OFDMA), and/or single-carrier FDMA (SCFDMA), among others.

As shown in FIG. 1A, the communication system 100 may include: (1) WTRUs 102a, 102b, 102c and/or 102d; (2) a RAN 104; a CN 106; a public switched telephone network (PSTN) 108; the Internet 110; and/or other networks 112. It is contemplated that the disclosed embodiments may include any number of WTRUs, base stations, networks, and/or network elements. Each of the WTRUs 102a, 102b, 102c, or 102d may be any type of device configured to operate and/or communicate in a wireless environment. By way of example, the WTRUs 102a, 102b, 102c or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, and/or consumer electronics, among others.

The communication system 100 may also include a base station 114a and a base station 114b. Each of the base stations 114a or 114b may be any type of device configured to wirelessly interface with at least one of the WTRU s 102a, 102b, 102c, and/or 102d to facilitate access to one or more communication networks, such as the CN 106, the Internet 110, and/or the other networks 112. By way of example, the base stations 114a and 114b may be a base transceiver station (BTS), a Node-B, an eNode B, a Home Node B, a Home eNode B, a site controller, an access point (AP), and/or a wireless router, among others. While the base stations 114a, 114b are each depicted as a single element, it is contemplated that the base stations 114a and 114b may include any number of interconnected base stations and/or network elements.

The base station 114a may be part of the RAN 104, which may include other base stations and/or network elements (not shown), such as a base station controller (BSC), a radio network controller (RNC), and/or relay nodes, among others. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three cell sectors. In certain exemplary embodiments, the base station 114a may include three transceivers, i.e., one for each sector of the cell. In various exemplary embodiments, the base station 114a may employ multiple-input multiple output (MIMO) technology and, may utilize multiple transceivers for each sector of the cell.

The base stations 114a and 114b may communicate with one or more of the WTRUs 102a, 102b, 102c and/or 102d over an air interface 116, which may be any suitable wireless communication link (e.g., radio frequency (RF), microwave, infrared (IR), ultraviolet (UV) and/or visible light, among others). The air interface 116 may be established using any suitable radio access technology (RAT).

As noted above, the communication system 100 may be a multiple access system and may employ one or more channel access schemes, such as CDMA, TDMA, FDMA, OFDMA, and/or SC-FDMA, among others. For example, the base station 114a in the RAN 104 and the WTRUs 102a, 102b, and 102c may implement a RAT such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In certain exemplary embodiments, the base station 114a and the WTRUs 102a, 102b and 102c may implement a RAT such as Evolved UMTS Terrestrial Radio Access (E-UTRA), which may establish the air interface 116 using Long Term Evolution (LTE) and/or LTE-Advanced (LTE-A).

In certain exemplary embodiments, the base station 114a and the WTRUs 102a, 102b and 102c may implement RAT such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), and/or GSM EDGE (GERAN), among others.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, and/or a campus, among others. In certain exemplary embodiments, the base station 114b and the WTRUs 102c and 102d may implement a RAT such as IEEE 802.11 to establish a wireless local area network (WLAN). In certain exemplary embodiments, the base station 114b and the WTRUs 102c and 102d may implement a RAT such as IEEE 802.15 to establish a wireless personal area network (WPAN). In certain exemplary embodiments, the base station 114b and the WTRUs 102c and 102d may utilize a cellular based RAT (e.g., WCDMA, CDMA2000, GSM, LTE, LTE-A, etc.) to establish a picocell or femtocell. As shown in FIG. 1A, the base station 114b may have a direct connection to the Internet 110. The base station 114b may access the Internet 110 via the CN 106 or may access the Internet directly or through a different access network.

The RAN 104 may be in communication with the CN 106, which may be any type of network configured to provide voice, data, applications, and/or voice over internet protocol (VoIP) services to one or more of the WTRUs 102a, 102b, 102c, and/or 102d. For example, the CN 106 may provide call control, billing services, mobile location-based services, pre-paid calling, Internet connectivity, video distribution, and/or perform high-level security functions, such as user authentication, among others. Although not shown in FIG. 1A, it is contemplated that the RAN 104 and/or the CN 106 may be in direct or indirect communication with other RANs that employ the same RAT as the RAN 104 or a different RAT. For example, in addition to being connected to the RAN 104, which may be utilizing an E-UTRA radio technology, the CN 106 may also be in communication with another RAN employing a GSM radio technology.

The CN 106 may also serve as a gateway for the WTRUs 102a, 102b, 102c, and 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The other networks 112 may include wired or wireless communication networks owned and/or operated by other service providers. For example, the other networks 112 may include another CN connected to one or more RANs, which may employ the same RAT as the RAN 104 or a different RAT.

Some or all of the WTRUs 102a, 102b, 102c and 102d in the communication system 100 may include multi-mode capabilities, (e.g., the WTRUs 102a, 102b, 102c, and/or 102d may include multiple transceivers for communicating with different wireless networks over different wireless links). For example, the WTRU 102c may be configured to communicate with the base station 114a, which may employ a cellular-based RAT, and with the base station 114b, which may employ an IEEE 802 RAT.

FIG. 1B is a system diagram illustrating a representative WTRU that may be used within the communication system illustrated in FIG. 1A.

As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and/or other peripherals 138, among others. It is contemplated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), and/or a state machine, among others. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. Although FIG. 1B depicts the processor 118 and the transceiver 120 as separate components, it is contemplated that the processor 118 and the transceiver 120 may be integrated together in an electronic package or chip. The transmit/receive element 122 may be configured to transmit signals to, or receive signals from, a base station (e.g., the base station 114a) over the air interface 116. For example, in certain exemplary embodiments, the transmit/receive element 122 may be an antenna configured to transmit and/or receive radio frequency (RF) signals. In various exemplary embodiments, the transmit/receive element 122 may be an emitter/detector configured to transmit and/or receive infrared (IR), ultraviolet (UV), and/or visible light signals, for example. In some exemplary embodiments, the transmit/receive element 122 may be configured to transmit and receive both RF and light signals. It is contemplated that the transmit/receive element 122 may be configured to transmit and/or receive any combination of wireless signals.

Although the transmit/receive element 122 is depicted in FIG. 1B, as a single element, the WTRU 102 may include any number of transmit/receive elements 122 and/or may employ MIMO technology. In certain exemplary embodiments, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. The transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) unit or organic light emitting diode (OLED) display unit). The processor 118 may output user data to the speaker/microphone 124, the keypad 126, and/or the display/touch pad 128. The processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of fixed memory storage device. The removable memory 132 may include a subscriber identity module (SIM) card, a memory stick, and/or a secure digital (SD) memory card, among others. In certain exemplary embodiments, the processor 118 may access information from, and store data in, memory that is not physically located at and/or on the WTRU 102, such as on a server or a home computer (not shown).

The processor 118 may be configured to receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), and/or lithium ion (Li-ion), among others), solar cells, and/or fuel cells, among others.

The processor 118 may be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a and/or 114b) and/or may determine its location based on the timing of the signals being received from two or more nearby base stations. It is contemplated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, and/or an Internet browser, among others.

FIG. 1C is a system diagram illustrating a representative RAN 104 and a representative CN 106 according to certain representative embodiments. The RAN 104 may employ the E-UTRA radio technology to communicate with the WTRU s 102a, 102b, and 102c over the air interface 116. The RAN 104 may be in communication with the CN 106.

Although the RAN 104 is shown to include eNode Bs 140a, 140b, and 140c, it is contemplated that the RAN 104 may include any number of eNode Bs. The eNode Bs 140a, 140b, and 140c may each include one or more transceivers for communicating with the WTRUs 102a, 102b, and 102c over the air interface 116. The eNode B 140a, for example, may use MIMO technology or may use multiple antennas to transmit wireless signals to, and receive wireless signals from, the WTRU 102a.

Each of the eNode Bs 140a, 140b, and/or 140c may be associated with a particular cell (not shown) and may be configured to handle radio resource management decisions, handover decisions, and/or scheduling of users in the UL and/or downlink (DL), among others. As shown in FIG. 1C, the eNode Bs 140a, 140b, and 140c may communicate with one another over an X2 interface.

The CN 106 may include a mobility management gateway (MME) 142, a SeGW 144, and a packet data network (PDN) gateway 146. Although each of the foregoing elements is depicted as part of the CN 106, it is contemplated that anyone of these elements may be owned and/or operated by an entity other than the CN operator.

The MME 142 may be connected to each of the eNode Bs 142a, 142b, and/or 142c in the RAN 104 via an S1 interface and may serve as a control node. For example, the MME 142 may be responsible for: (1) authenticating users of the WTRUs 102a, 102b, and 102c; (2) bearer activation/deactivation; and/or (3) selecting a particular SeGW during an initial attach (e.g., attachment procedure) of the WTRUs 102a, 102b, and 102c, among others. The MME 142 may provide a control plane function for switching between the RAN 104 and other RANs that employ other RAT, such as GSM or WCDMA.

The serving gateway (SeGW) 144 may be connected to each of the eNode Bs 140a, 140b, and 140c in the RAN 104 via the S1 interface. The SeGW 144 may generally route and forward user data packets to/from the WTRUs 102a, 102b and 102c. The SeGW 144 may perform other functions, such as anchoring user planes during inter-eNode B handovers, triggering paging when DL data is available for the WTRUs 102a, 102b, and 102c, and/or managing and storing contexts of the WTRUs 102a, 102b and 102c, among others.

The SeGW 144 may be connected to the PDN gateway 146, which may provide the WTRU s 102a, 102b, and 102c with access to packet-switched networks, such as the Internet 110, to facilitate communications between the WTRUs 102a, 102b and 102c and IP-enabled devices.

The CN 106 may facilitate communications with other networks. For example, the CN 106 may provide the WTRUs 102a, 102b and 102c with access to circuit-switched networks, such as the PSTN 108, to facilitate communications between the WTRUs 102a, 102b and 102c and traditional land-line communication devices. For example, the CN 106 may include, or may communicate with, an IP gateway (e.g., an IP multimedia subsystem (IMS) server) that may serve as an interface between the CN 106 and the PSTN 108. The CN 106 may provide the WTRUs 102a, 102b, and 102c with access to the other networks 112, which may include other wired or wireless networks that are owned and/or operated by other service providers.

An ICN network may decouple content from hosts at the network level and retrieve a content object by its name (e.g., an identifier), instead of its storage location (e.g., host IP address), in order to address an IP network's limitations in supporting content distribution. ICN systems may face scalability and efficiency challenges in global deployments.

The number of content objects may be large, and may be rapidly growing. These objects may be stored at any location in the Internet, and may be created, replicated and deleted in a dynamic manner.

Content advertisement may be different from IP routing in that the number of content objects may be much larger. Content advertisement may use different operations to cope with scalability.

The scalability and efficiency of ICNs may be affected by naming, name aggregation, and routing and name resolution schemes. The names of content objects may be aggregated in publishing content locations, and content routing and name resolution may be optimized.

The mechanisms for content naming, routing and name resolution may vary depending upon the ICN architecture. In some ICN networks, flat self-certifying names may be employed, whereas in others, a hierarchical naming scheme with binary-encoded uniform resource locators (URLs) may be used.

In content publishing, content availability may be announced to other content routers (CRs) via a traditional flooding protocol or a distributed hash table (DHT) scheme, among others. To retrieve a content object, a request may be forwarded to the best content source or sources in the network employing either a direct name-based routing on the requested object identifier (ID) or a name resolution process that resolves an ID into a network location, (e.g., an IP address or a more general directive for forwarding).

In certain representative embodiments, procedures, methods and/or architectures for matching publishers and subscribers of information in an ICN system may be implemented.

In certain representative embodiments, the matching operation may include matching based on any of: (1) locations of the publishers and/or subscribers; (2) a form of publisher identity information; (3) privacy requirements; (4) a price constraint (e.g., a per item constraint); and/or (5) a Quality of Experience (QoE) for the item.

In certain representative embodiments, the matching operation may occur, for example, in the L3 layer and/or the application layer.

In certain representative embodiments, information may be routed rather than bit packets being sent from endpoint A to endpoint B. An operation for routing information within ICN networks or using ICN networks may include a rendezvous, which may match the publishers of information and the subscribers to the information into a temporal relationship (e.g., a temporal communication relationship). The relationship, which may be created on-the-fly (e.g., dynamically) may enable forwarding of the particular information from the chosen publisher or publishers to the subscriber or subscribers. In certain scenarios, the rendezvous operation may perform (e.g., generally perform) a non-discriminative match (e.g., a single publisher may be selected from a set of matching publishers offering the information and all subscribers (who have currently subscribed to the information) may be chosen for the match. In the case of several potential publishers, one publisher may be chosen (e.g., randomly chosen) in the matching operation. In one example, the procedure may be performed offline and may lead to the population of Forwarding Information Bases (FIB) routing tables in an intermediary forwarding elements. In another example, a centralized rendezvous function or unit may perform the matching operation with received publications and/or subscriptions (e.g., every one or a portion of the received publications and/or subscriptions).

In certain examples, real-time FIBs and the determination of a forwarding path to subscribers may be eliminated by relying on, for example, “scope trees.” In other examples, a per-scope centralized entity referred to as a “scope root” may match each content request with the location (e.g., ultimate location) of the content, for example, on condition that several potential locations exist.

Non-discriminative matching may be implemented through basic operations of an ICN. For example, publishers and subscribers may be brought together or matched solely based on information offered by the publishers and subscribers. By including discriminative matching operations, selection of publishers and subscribers may be based on a clearly formulated discriminative factor (e.g., one or more matching constraints). The matching constraint may itself be dependent on publisher and/or subscriber information and/or constraints relating to the information itself.

### Representative Setup Procedures

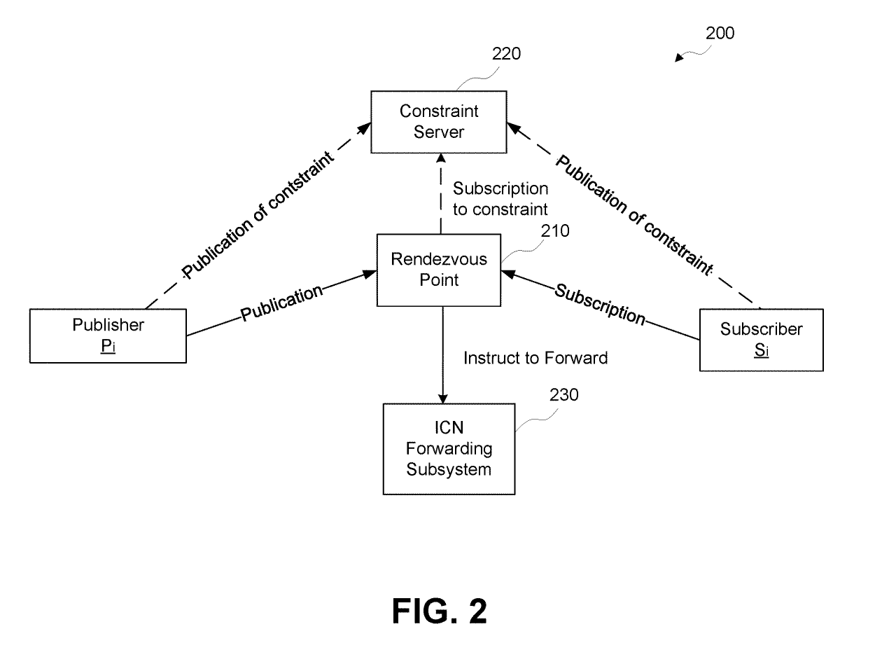

A centralized rendezvous point (e.g., logically centralized and/or physically centralized) may perform matching of publishers and subscribers. A publisher may be an application endpoint and/or any network node which can deliver (e.g., publish) content. A subscriber may be an application endpoint (e.g., a different application endpoint and/or any network node, which can receive or request (e.g., subscribe to) content. The incoming subscription may be processed by the publisher at the time of the incoming subscription. The incoming publication may be processed by the subscriber at the time of the incoming publication. In certain representative embodiments, a constraint server (CS), for example, which may be another ICN rendezvous point, may hold and/or may store a constraints namespace. Publishers and subscribers of information may publish their constraints to the CS, as shown in FIG. 2. When performing a match of a subscription and publication at the rendezvous point (also sometimes referred to as a network node and/or rendezvous server), the rendezvous point may subscribe to one or more constraints (e.g., appropriate constraints) at the CS.

After a match (e.g., a successful match), the rendezvous point may facilitate the delivery of the information as instructed by (e.g., provided for using) the match information. In certain representative embodiments, a topology manager may forward the match (and/or enable forwarding of the requested content) of one or more publishers to one or more subscribers. In other representative embodiments, an ICN forwarding subsystem (FS) may forward the match and/or the requested content. The topology manager may determine a source route (e.g., for a stateless forwarding operation) within the ICN network. In certain representative embodiments, a root node may be forwarded the requested content. The root node may forward and/or route the requested content using (e.g., down) a well-defined scope tree (e.g., associated with one or more nodes of the network). In certain representative embodiments, the FIBs may be pre-defined and the FS may be set (e.g., “fixed” from the point of view of forwarding each particular content).

Although one rendezvous point is shown, the network may include any number of rendezvous points which, for example, may each manage a portion of the publishers and/or subscribers.

The rendezvous point may provide for matching of publishers and subscribers and may be provided as a standalone entity, a server and/or a part of an existing network node.

Although one CS is shown, the network may include any number of CSs which, for example, may be standalone or included as part of any existing network entity.

FIG. 2 is a block diagram illustrating a representative ICN system 200.

Referring to FIG. 2, the representative ICN system 200 may include a rendezvous point/server (RP/RS) 210, a CS 220 and/or an ICN FS 230. One or more publishers Pᵢ may publish to and/or at the RP/RS 210, and one or more subscribers Sᵢ may subscribe to and/or at the RP/RS 210. The CS 220 may be implemented as a stand-alone component or may be integrated into another network entity. For example, the subscribers Sᵢ and/or the publishers Pᵢ may publish constraints to, at, held by and/or stored in the CS 220. The RP/RS 210 may subscribe to the constraints stored in the CS 220. The RP/RS 210 may perform a discriminative matching operation using the subscribed to contents (e.g., constraints) from the CS 220. For example, the RP/RS 210 may receive constraint information from the CS 220 that was received/collected from the one or more publishers Pᵢ and/or the one or more subscribers Sᵢ. The RP/RS 210 may match a subscriber Sᵢ to a publisher Pᵢ using the constraint information.

The RP/RS 210 may associate publisher information to a publisher Pᵢ (e.g., each publisher) and subscriber information to a subscriber Sᵢ (e.g., each subscriber, each requestor and/or each client). In certain representative embodiments, the publisher information and/or subscriber information may be a basis, at least in part, for the matching operation (e.g., used as part of a constraint matching mechanism). A RP/RS 210 may maintain a set of publishers Pᵢ (e.g., publishers P_{CID}={Pᵢ; where i may be the number of publishers indicating the availability of data}) and a set of subscribers Sᵢ (e.g., subscribers S_{CID}={Sⱼ, where j may be the number of subscribers indicating a demand for data}) for one or more content identifiers (CIDs) that have been published and/or subscribed to via or at the RP/RS 210. The set of subscribers Sᵢ, the set of publishers Pᵢ, and their associated CIDs may enable non-discriminative matching operations. In certain representative embodiments, the set of subscribers Sᵢ, the set of publishers Pᵢ, their associated CIDs and the constraint information may enable discriminative matching operations as set forth herein.

### Representative Constrained Matching Operation

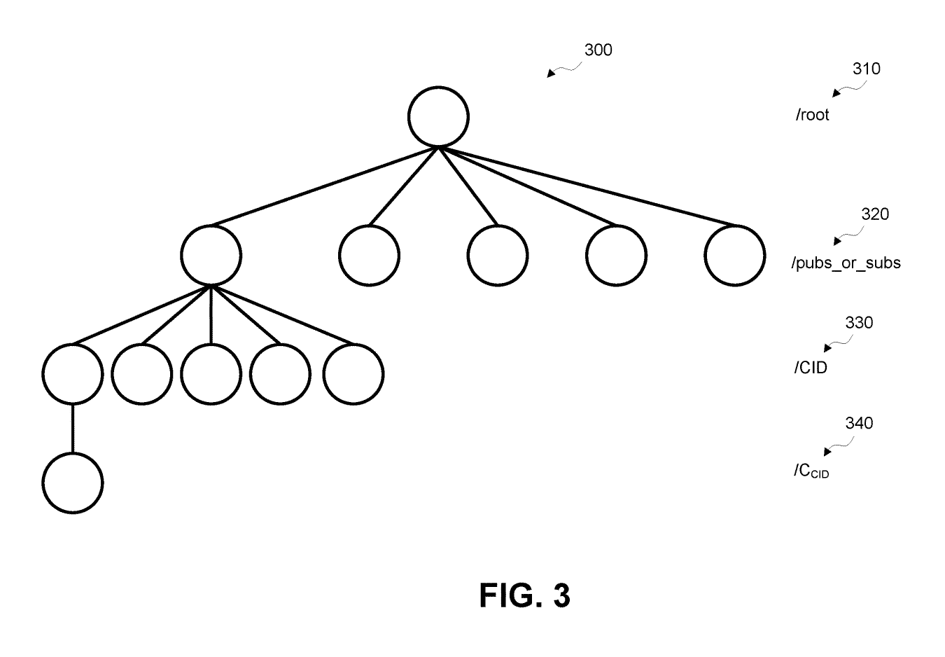

FIG. 3 illustrates a representative constraints namespace 300 that may be used by one or more publishers and/or by one or more subscribers with respect to CIDs that are published or subscribed to.

Referring to FIG. 3, the constraints namespace 300 (e.g., a parallel namespace) may include a tree structure 305, which may have a first level 310, as the root, a second level 320 as the publishers and/or subscribers, a third level 330, as the CID and/or a fourth level 340, as the constraints for the CID (Coo) In certain representative embodiments, certain information including namespace information may be provided to, requested by, obtained by and/or stored at the RP/RS 210. For example, the constraints namespace 300 (e.g., a parallel namespace) may be established. The parallel namespace generally refers to a namespace for the constraints that may be matched during the constrained matching operation (e.g., in the RP/RS). As an example, one or more publishers Pᵢ and one or more subscribers Sᵢ may publish (e.g., may each publish) a constraint C_{CID} to the RP/RS 210 under the identifier /root/Pᵢ/CID for the respective publisher Pᵢ or under the identifier /root/Sᵢ/CID for the respective subscriber Sᵢ. The publishers Pᵢ and the subscribers Sᵢ relative to the information CID may both act as a publisher Pᵢ of the respective constraint information for the CID. The RP/RS 210 may act as a subscriber to the constraint information of the CS 220. In certain representative embodiments, the scope root may be a subscriber of all CID for the scope, which is natural, as it may be the default “recipient” of publication and/or subscription announcements (e.g., all publication and/or subscription announcements). In certain representative embodiments, the RP/RS 210 may subscribe to specific information (e.g., only specific information), based on the content identifiers that are maintained at the RP/RS 210. The RP/RS 210 may receive a subscription from subscriber Sᵢ and/or a publication from publisher Pᵢ to information CID. The RP/RS 210 may subscribe to any of: /root/Sᵢ/CID and/or /root/Pᵢ/CID and the CS 220 may publish or may have published the constraints namespace 300. The RP/RS 210 (e.g., as a consequence of its subscription), may receive the appropriate constraint information.

It is contemplated that the RP/RS 210 may subscribe to the constraint root identifier /root and may obtain a portion of the constraints namespace 300 or the full constraints namespace 300 (e.g., locally and/or at the RP/RS 210).

It is contemplated that in certain representative embodiments that the CS 220 may be a separate entity (e.g., separate network entity). In other representative embodiments, the CS 220 may be combined with other network resources such as the RP/RS 210, or other network devices, among others.

The publishers Pᵢ and/or the subscribers Sᵢ may use wildcards and/or specific CIDs when providing or signaling constraints to allow for general or specific constraints (e.g., which may be applicable to one, some, substantially all, or all content identifiers). The wildcard may be represented by a special CID (e.g., such as 0xffffffff).

Although FIG. 3 illustrates a single Coo, it is contemplated that any number of C_{CID} may be leafs under a CID. For example: (1) each root may include any number of publishers Pᵢ and/or subscribers Sᵢ; (2) each publisher Pᵢ and/or subscriber Sᵢ may include any number of CIDs; and (3) each CID may include any number of constraints (e.g., constraint information C_{CID}).

### Representative Constraint Encoding Operation

The constraints namespace 300 itself may be populated with the constraint information. For example, the constraint information may be populated into or encoded in the leafs of the constraints namespace 300.

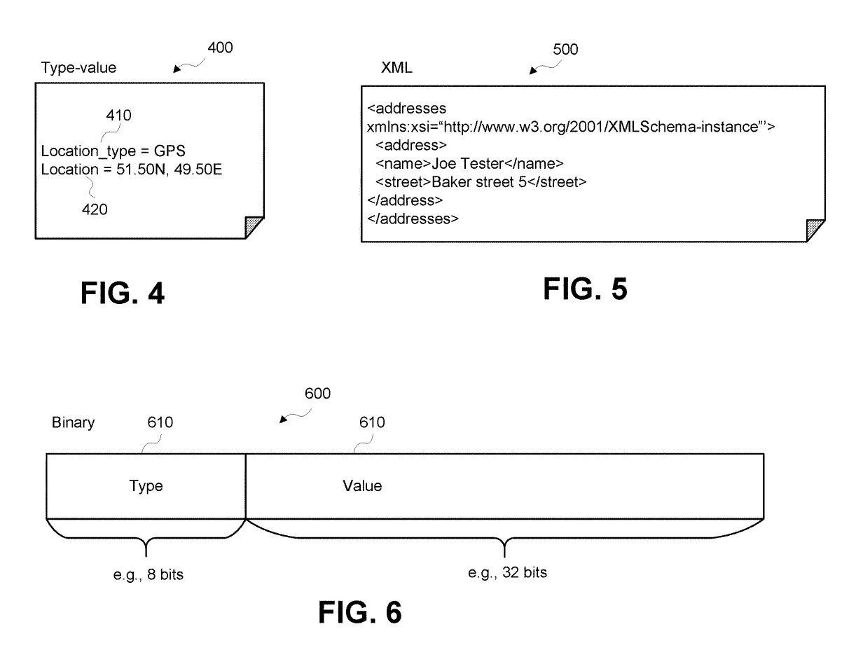

FIG. 4 illustrates the encoding of constraints using, for example, a type-value text format. FIG. 5 illustrates the encoding of constraints using, for example, an XML-encoded text format, FIG. 6 illustrates the encoding of constraints using, for example, a binary encoding format. FIGS. 4-6 may encode location information associated with the publisher Pᵢ and/or subscriber Sᵢ.

Referring to FIG. 4, a first representative constraint encoding format 400 may use a type-value text format that may include location encoded information including location_type 410 (for example GPS, ISP, country, Zone, Physical Address and/or Logical Address) and location 420 (e.g., location information).

For example: (1) a location_type 410 of GPS may indicate that the location 420 is location coordinates such that the discriminative matching may be based on, for example the location coordinates of the subscriber Sᵢ and publisher Pᵢ; (2) a location_type 410 of ISP may indicate that the location 420 is a particular ISP (e.g., an ISP name or identifier) such that the discriminative matching may be based on, for example the matching of ISPs of the subscriber Sᵢ and publisher Pᵢ; (3) a location_type 410 of a country may indicate that the location 420 is a particular country (e.g., a country or country code, for example “UK” for United Kingdom) such that the discriminative matching may be based on, for example the matching of the country or country or country code of the subscriber Sᵢ and publisher Pᵢ; (4) a location_type 410 of Zone may indicate that the location 420 is a particular Zone (e.g., a “Small Cell Zone” as defined by the Small Cells Forum, for example, “Starbucks” may be defined as a Zone associated with and/or covering APs located within a Starbucks store and/or location) such that the discriminative matching may be based on, for example the matching of the particular Zone information of the subscriber Sᵢ and publisher Pᵢ; (5) a location_type 410 of a Physical Address may indicate that the location 420 is a particular Physical Address, for example, a street address such that the discriminative matching may be based on, for example the matching of the particular physical addresses, (e.g., based on a distance measure) of the subscriber Sᵢ and publisher Pᵢ; and/or (6) a location_type 410 of a logical address may indicate that the location 420 is a particular Logical Address, for example, a IP address such that the discriminative matching may be based on, for example the matching of the particular logical addresses, for example based on a logical distance measure of the subscriber Sᵢ and publisher Pᵢ.

Referring now to FIG. 5, a second representative constraint encoding format 500 may use a XML-encoded text format and may include that may include location encoded information including an address element with nested name and street elements.

Referring now to FIG. 6, a third representative constraint encoding format 600 may use a binary encoded format and may include both a type field 610 and a value field 620.

Although a location information is shown in FIGS. 4-5 and may be used with any of the encoding formats disclosed herein, one of skill in the art understands that other constraint information may be encoded in addition to or in lieu of the location information. For example, the constraint information may include any of: (1) location information; (2) territory and/or country information; (3) zone information; (4) identity information; (5) owner information; (6) privacy-related information; and/or (7) QoE information, among others.

### Representative Constraints Definition and Usage

As described herein, the one or more publishers Pᵢ and/or one or more subscribers Sᵢ in the ICN system 200 may be responsible for publishing the relevant constraint information C_{CID} in the respective part of the constraints namespace 300 of FIG. 3. For example, the constraint information C_{CID} may be established and/or defined as part of an application package (e.g., an application that may implement the publisher and subscriber functionality within the ICN system 200). In certain representative embodiments, the constraint information C_{CID} may be defined through appropriate settings of constraints within the application. For example, the ICN network interface may provide a mechanism to publish and/or to subscribe to (or request and deliver) information using constraint information C_{CID} and may leave the definition of the constraint information C_{CID} to the application. For example, an application may define or establish one or more constraints that may enable the application to be aware of those constraint, as certain constraints involved may necessitate or may require application awareness.

In other representative embodiments, the constraints may be defined at a service level (e.g., when deploying a service across a distributed set of one or more publishers and one or more subscribers in the ICN network). As an example, constraints pertaining to a video delivery service such as NetFlix may be published by appropriate publisher and subscriber applications, enabling the delivery of content. In certain representative embodiments, the published constraints may allow a RP/RS 210 to ensure that the delivery of content is only facilitated when these constraints are matched (e.g., regarding the minimal constraints such as bandwidth that may be guaranteed for optimal QoE). The constraints may be associated with the publisher Pᵢ, the subscriber Pᵢ and/or the network itself. The constraint information C_{CID} may be defined out-of-band (e.g., through setting files that may be deployed, for example alone or in combination with service agents). The constraint information C_{CID} may be used by the publishers Pᵢ and/or the subscribers Sᵢ and/or requestors during the operation of the service over the network. The defined and/or established constraints may pertain directly or indirectly to network operations over which the service is provided. Additional detailed examples are provided herein.

### Representative Constraint Matching Operation

The representative constraints namespace 300 illustrated in FIG. 3 may be used in the matching operation of publishers Pᵢ and subscribers Sᵢ to the actual content information identified through CID.

The full constraints namespace 300 may be maintained at the RP/RS 210 (e.g., the RP/RS 210 may have subscribed to the constraint root identifier /root). In certain representative embodiments, information about certain CIDs may be pulled on-the-fly (dynamically updated) by the RP/RS 210 that subscribes to a specific /root/Pᵢ identifier at the time of the matching operation and the constraint information C_{CID} may be published by the CS 220.

In certain representative embodiments, all sub-identifiers may be found by subscribing to the scope represented by /root/Pᵢ/CID and /root/Sᵢ/CID, respectively. A representative constraint-based matching operation may include one or more of the following procedures: (1) receiving either publication or subscription to information with identifier CID; (2) determining a set of publishers P and a set of subscribers S (e.g., using the CIDs associated with the publishers and subscribers; and (3) for each Pᵢ in set P and each Sᵢ in set S, find all sub-identifier(s) /CID/C_{CID} in the constraints namespace 300 of FIG. 3, for example, by subscribing to the scope represented by /root/Pᵢ/CID and /root/Sᵢ/CID, respectively; (4) determining the subsets P′ of P and S′ of S according to a defined matching policy M; and/or (5) instructing the ICN FS 430 to exchange information between P′ and S′. In certain representative embodiments, if a wildcard CID (e.g., 0xffffffff) exists, under /root/Pᵢ and/or /root/Sᵢ, the constraint information C_{CID} for this wildcard may be used for the matching operation in lieu of or in addition to any of the procedures set forth.

### Representative Matching Operation Embodiments

It is contemplated that any number of different embodiments for the constraint matching operations may exist based on different matching policies. For example, the matching operation may be based on any one or more of: (1) location information; (2) territory and/or country information; (3) zone information; (4) identity information; (5) owner information; (6) privacy-related information; and/or (7) QoE information, among others.

The matching operation may include:

(1) Matching based on location, for example, base (e.g., location) information may be encoded as a constraint. In one embodiment, the location information can be that of an Internet Service Provider (ISP) (e.g., an ISP name or identifier) and the matching may result in publishers and subscribers from a single ISP being chosen. This may be useful for clustering publishers Pᵢ and subscribers Sᵢ based on ISP for optimizing the delivery over a single network (e.g., rather than involving publisher/subscriber relationships that may span peering links). In another representative embodiment, the location information may be that of a country or country code (e.g., “UK” or indicating “UK”), allowing for matching operations that result in country-level sets of one or more publishers Pᵢ and/or one or more subscribers Sᵢ, for example, which may be useful for implementing geolocation services in video distribution, such as BBC iPlayer-like offerings. In certain representative embodiments, the location information may be determined via a GPS of a device and may be stored as constraint information Coo. The constraint information C_{CID} may be used by an application when publishing information and/or subscribing to information. In further representative embodiments, the location information may be a Zone, for example a “Small Cell Zone” as defined by the Small Cells Forum. In a wireless network, a Zone may be a grouping of access points (APs) (e.g., base stations, small cells, and/or WiFi APs, among others) which may be associated with a well-known context. For example, “Starbucks” may be defined as a Zone associated with and/or covering APs located within a Starbucks store and/or location. The owner/operator of these APs may provide information about the user device's attachment to an AP within the Zone as a type of context-rich location service (e.g., allowing a service to target devices that are within, in the vicinity of and/or associated with a Starbucks by focusing on a “Starbucks” zone). The name of a Zone may be well defined and may be published by the operator providing the service.

(2) Matching based on identity information, for example, identity information may be encoded as a constraint. It is contemplated that the identity information may be (e.g., may usually be) an application-level identity and may be different from the publisher's identity at the ICN level (e.g., the Pᵢ identifier herein). In certain representative embodiments, the identity or identity information may be that of a specific social media site (e.g., Facebook, Linked-in, and/or Snap-Chat, among others). The matching operation between publishers Pᵢ and subscribers Sᵢ may result in information being exchanged (e.g., only being exchanged) when or on condition that the identities (for example, the domain, such as Facebook) match. The matching operation using such identities may be useful to enable group-based exchange of information, such as within group messaging boards. In certain representative embodiments, the identity may be secured from some or all network entities. For example, a XAuth token may be used in place of the identity to verify the common identity match to network entities (for example to the RP/RS 210). The group and/or individual identities may be kept secure. In certain representative embodiments, the token may to be generated via an application exchange and may be used when publishing and/or subscribing to information. In another representative embodiment, the identity may be that of the “owner” of the exchange information (e.g., owner@email.com). In certain representative embodiments, the constraint match operation may match a portion of or all of the identity information. For example, information may be exchanged (e.g., may only be exchanged) between publishers Pᵢ and subscribers Sᵢ that are constrained by the same owner identity. The use of owner identity as a constraint may be useful for personal cloud type of offerings. Such identity information may be defined in some account setup procedure within an application package, which may be used when publishing information and/or subscribing to information.

(3) Matching based on privacy requirements, for example, the constraint information C_{CID} may include privacy-related information, such as encryption level being provided and/or required for exchanging the information. In certain representative embodiments, the encryption information may be used as a clear name in the encoded constraint information C_{CID} and/or the encryption information may be a reference to an encryption standard. The encryption information may useful for matching publishers Pᵢ and subscribers Sᵢ (e.g., only publishers and subscribers) that follow a particular and/or required encryption level for the exchange of information.

(4) Matching based on price, for example, the constraint information C_{CID} may encode pricing information. In certain representative embodiments, fine-grained pricing information may be included and/or attached with each exchanged piece of information. In certain representative embodiments, the price information may be an absolute price. In certain representative embodiments, the pricing information may include information associated with a type of currency (e.g., US dollars and/or euros, among others). In certain representative embodiments, the pricing information may including information for a clearing/payment site (e.g., PayPal, Visa, and/or Mastercard, among others) to be used for payment. The pricing information may be useful, for example, for a simple micropayment type of exchange. In certain representative embodiments, the price information may be that of a pricing strategy, for example, publishers Pᵢ and subscribers Sᵢ (e.g., only publishers Pᵢ and subscribers Sᵢ) with compatible payment strategy (e.g., flat rate pricing, usage-based pricing, and/or auction-based pricing, among others) may be matched, possibly followed by an appropriate payment procedure for the exchange.

(5) Matching based on QoE information, for example, the constraint information C_{CID} may encode QoE-related information. In certain representative embodiments, the QoE information may include video encoding information (e.g., video encoding information to ensure minimal QoE) that may be used for playing out the associated content (e.g., via a CID). A constrained match may result in information exchange between publishers Pᵢ and subscribers Sᵢ (e.g., only publishers Pᵢ and subscribers Sᵢ) that adhere to a minimal playout quality. The QoE-related information may be useful for content provider policies that demand a minimal playout quality for satisfying a well-understood minimal QoE with their customer base. In certain representative embodiments, the QoE information may include the maximal quality, which may be useful to the subscriber Sᵢ, for example, due to screen size and other user viewing constraints such as viewing angle and proximity to the screen. A constrained match may result in information exchange between publishers Pᵢ and subscribers Sᵢ (e.g., only between publishers Pᵢ and subscribers Sᵢ) that may adhere to the minimal and/or maximal constraints. In certain representative embodiments, the QoE information may include access bandwidth information for respective publishers Pᵢ and/or subscribers Sᵢ. In certain representative embodiments, the bandwidth information may be configured manually or automatically in the client. In certain representative embodiments, the bandwidth information may be measured (e.g., automatically measured) with frequent updates to the constraint information C_{CID} based on these measurements. For example, publishers Pᵢ and subscribers Sᵢ with a minimal and/or a maximal access bandwidth may be matched to ensure a certain level of playout for the associated information CID. In a further embodiment, the QoE information may refer to a latency which may be sustained. A match may result when (e.g., only when) a publisher Pᵢ can deliver information at a pre-defined latency. The latency constraint information may be useful for interactive services, video services and/or real-time services.

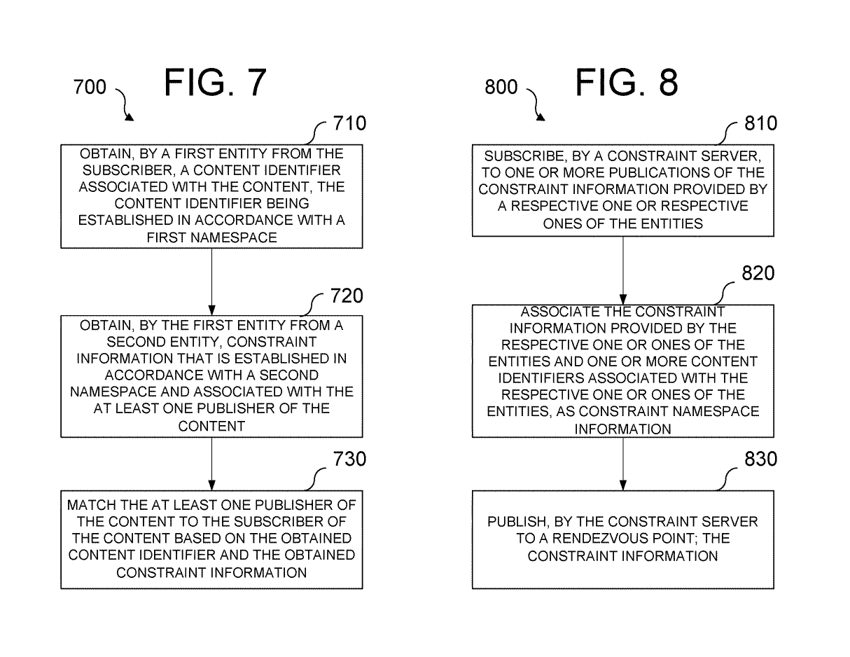

FIG. 7 is a flow chart illustrating a representative matching method.

Referring to FIG. 7, the representative matching method 700 may match at least one publisher Pᵢ of content to a subscriber Sᵢ of the content. At block 710, a first entity 210 may obtain from the subscriber Sᵢ, a content identifier CID associated with the content. The content identifier may be established in accordance with a first namespace. At block 720, the first entity 210 may obtain from a second entity 220, constraint information C_{CID} that may be established in accordance with a second namespace 300 and associated with the at least one publisher Pᵢ of the content. At block 730, the first entity 210 may match the at least one publisher Pᵢ of the content to the subscriber Sᵢ of the content based on the obtained content identifier CID and the obtained constraint information C_{CID}.

In certain representative embodiments, the obtaining of the content identifier CID may include receiving a request for the content. The request for the content may include the content identifier CID.

In certain representative embodiments, the first namespace may be established, as a content namespace, that is associated with content identifiers CIDs and the second namespace 300 may be established, as a constraint namespace, which is independent of the content namespace.

In certain representative embodiments, the matching of the at least one publisher Pᵢ of content to the subscriber Sᵢ of the content may include: a content identifier CID of the at least one publisher Pᵢ being matched to a content identifier CID of the subscriber Sᵢ and one or more rules being satisfied using the constraint information C_{CID} associated with the at least one publisher Pᵢ and other constraint information C_{CID} associated with the subscriber Sᵢ.

In certain representative embodiments, the matching of the at least one publisher Pᵢ of the content to the subscriber Sᵢ of the content may include matching based on any of: (1) location information; (2) territory and/or country information; (3) zone information; (4) identity information; (5) owner information; (6) privacy-related information; (7) QoE information; (8) a price constraint and/or (9) operational information associated with network operations.

In certain representative embodiments, the obtaining of the constraint information C_{CID} may include the first entity 210 subscribing to the constraint information C_{CID} stored in the second entity 220 via a scope represented by a portion of a logical structure in the second entity 220 based on the content identifiers CIDs that are maintained at the first entity 210.

In certain representative embodiments, the obtaining of the constraint information C_{CID} associated with the at least one publisher Pᵢ of the content may include the first entity 210 obtaining from the second entity 220 first constraint information C_{CID} associated with the at least one publisher Pᵢ and second constraint information C_{CID} associated with the subscriber Sᵢ.

In certain representative embodiments, the matching of the at least one publisher Pᵢ of the content to the subscriber Sᵢ of the content may be based on a match of the obtained content identifier CID and satisfaction of one or more rules using the obtained first and second constraint information C_{CID}.

In certain representative embodiments, the constraint information C_{CID} associated with the subscriber Sᵢ may be obtained from a request of the subscriber Sᵢ, the constraint information C_{CID} being provided along with the content identifier CID.

In certain representative embodiments, the constraint information C_{CID} associated with the subscriber Sᵢ may be sent from the first entity 210 to the second entity 220.

In certain representative embodiments, the first and second entities 210 and 220 may be encompassed in a single device.

FIG. 8 is a flow chart illustrating a representative constraint management method.

Referring to FIG. 8, the representative constraint management method 800 may managing constraints associated with a constraint namespace 300 using a plurality of entities Sᵢ, and Pᵢ by establishing constraint information C_{CID} in accordance with a predefined constraint namespace. At block 810, a constraint server 220 may subscribe to one or more publications of the constraint information C_{CID} provided by a respective one or respective ones of the entities Sᵢ, and Pᵢ. At block 820, the constraint information C_{CID} provided by the respective one or ones of the entities Sᵢ, and Pᵢ and one or more content identifiers CIDs associated with the respective one or ones of the entities Sᵢ, and Pᵢ may be associated, as constraint namespace information. At block 830, the constraint server 220 may publish to a rendezvous point 210 the constraint information C_{CID}.

In certain representative embodiments, a first namespace, as a content namespace, that is associated with content identifiers CIDs may be established.

In certain representative embodiments, the constraint namespace 300, as a second, independent namespace may be established.

In certain representative embodiments, the associating of the constraint information C_{CID} provided by the respective one or ones of the entities Pᵢ and Sᵢ and the one or more content identifiers CIDs associated with the respective one or ones of the entities Pᵢ and Sᵢ, as the constraint namespace information may include: a logical structure which includes a plurality of levels 310, 320, 330 and 340 being established and the constraint server 220 storing the constraint information C_{CID} in a lowest level 340 of the logical structure.

In certain representative embodiments, the establishing of the logical structure may include: a highest level 310 of the logical structure being set, as a root level node of the logical structure and a first level 320 of the logical structure being set with a plurality of first level nodes such that each first level node may be associated with the root level node of the logical structure.

In certain representative embodiments, the establishing of the logical structure may include a second level 330 of the logical structure being set with a plurality of second level nodes such that each second level node may be associated with one of the first level nodes of the logical structure.

In certain representative embodiments, the establishing of the logical structure may include a lowest level 330 of the logical structure being set with a plurality of third level nodes such that each third level node may be associated with one of the second level nodes of the logical structure.

In certain representative embodiments, respectively different publisher identifiers and/or subscriber identifiers may be stored in one or more first level nodes of the logical structure.

In certain representative embodiments, a single content identifier CID associated with the content may be stored in a second level node associated with a respective one of the first level nodes.

In certain representative embodiments, the constraint information C_{CID} may be stored in the third level node and associated with a respective one of the second level nodes that stores a single content identifier CID.

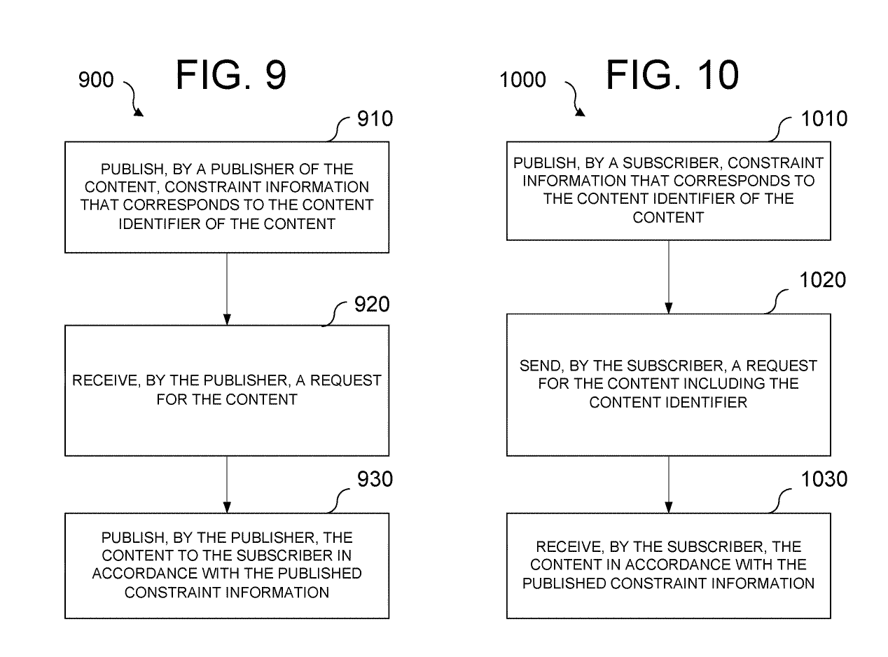

FIG. 9 is a flow chart illustrating a representative publishing method.

Referring to FIG. 9, the representative publishing method 900 may use a content identifier CID. At block 910, a publisher Pᵢ of the content may publish constraint information C_{CID} that corresponds to the content identifier CID of the content. At block 920, the publisher Pᵢ may receive a request for the content. At block 930 the publisher Pᵢ may publish the content to the subscriber Sᵢ in accordance with the published constraint information C_{CID}.

In certain representative embodiments, the publishing of the content to the subscriber Sᵢ in accordance with the published constraint information C_{CID} may include publishing the content to the subscriber Sᵢ on condition that a constraint associated with the published constraint information C_{CID} corresponding to the content identifier CID is satisfied.

In certain representative embodiments, the constraint information C_{CID} may include the constraint associated with any of: (1) location information of the publisher Pᵢ; (2) territory and/or country information of the publisher Pᵢ; (3) zone information of the publisher Pᵢ; (4) privacy-related information associated with handling of the content, subscriber information or publisher information; (5) QoE information associated with handling of the content for publication by the publisher Pᵢ; (6) a price constraint for charging of the subscriber on reception of the content by the subscriber Sᵢ; and/or (7) operational information associated with network operations.

FIG. 10 is a flow chart illustrating a representative subscribing method.

Referring to FIG. 10, the representative subscribing method 1000 may use a content identifier CID. At block 1010, a subscriber Sᵢ may publish constraint information C_{CID} that corresponds to the content identifier CID of the content. At block 1020, a subscriber may send a request for the content and may include the content identifier CID. At block 1030, a subscriber may configure itself to receive the content in accordance with the published constraint information C_{CID}.

In certain representative embodiments, the receiving of the content in accordance with the published constraint information C_{CID} may include receiving the content on condition that a constraint associated with the published constraint information C_{CID} corresponding to the content identifier CID is satisfied.

In certain representative embodiments, the constraint information C_{CID} may include the constraint associated with any of: (1) location information of the subscriber Sᵢ (2) territory and/or country information of the subscriber Sᵢ; (3) zone information of the subscriber Sᵢ; (4) privacy-related information associated with handling of the content, subscriber information or publisher information; (5) QoE information associated with handling of the content by the subscriber Sᵢ; and/or (6) a price constraint for charging of the subscriber Sᵢ on reception of the content by the subscriber Sᵢ and/or (7) operational information associated with network operations.

The contents of each of the following references are incorporated herein by reference: (1) V. Jacobson, “Networking named content”, Proceedings of the 5th international conference on Emerging networking experiments and technologies, ACM CoNext, 2009; (2) D. Trossen, G. Parisis, Designing and Realizing An Information-Centric Internet, IEEE Communications Magazine Special Issue on “Information-centric Networking”, July 2012; (3) D. Trossen, G. Biczok, Not Paying the Truck Driver: Differentiated Pricing for the Future Internet, ReArch 2010 workshop in conjunction with ACM Conext, December 2010; and (4) Small Cells Forum, SCF084: SmallCell Zone Services: RESTful Binding, available via: http://www.scf.io/en/documents/084_-Small_Cell_Zone_services_RESTful_Bindings.php.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, WTRU, terminal, base station, RNC, or any host computer.

Moreover, in the embodiments described above, processing platforms, computing systems, controllers, and other devices including the CS 220 and the RP/RS 210 containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any WTRU recited herein.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REPRESENTATIVE EMBODIMENTS

In a first representative embodiment, a method of matching at least one publisher of content to a subscriber of the content is disclosed. The method comprises: obtaining, by a first entity from the subscriber, a content identifier associated with the content, the content identifier being established in accordance with a first namespace; obtaining, by the first entity from a second entity, constraint information that is established in accordance with a second namespace and associated with the at least one publisher of the content; and matching the at least one publisher of the content to the subscriber of the content based on the obtained content identifier and the obtained constraint information.

In a second representative embodiment, a method of managing constraints associated with a constraint namespace using a plurality of entities by establishing constraint information in accordance with a predefined constraint namespace is disclosed. The method comprises: subscribing, by a constraint server, to one or more publications of the constraint information provided by a respective one or respective ones of the entities; associating the constraint information provided by the respective one or ones of the entities and one or more content identifiers associated with the respective one or ones of the entities, as constraint namespace information; and publishing, by the constraint server to a rendezvous point; the constraint information.

In a third representative embodiment, a method of publishing content that is associated with a content identifier is disclosed. The method comprises: publishing, by a publisher of the content, constraint information that corresponds to the content identifier of the content; receiving, by the publisher, a request for the content; and publishing, by the publisher, the content to the subscriber in accordance with the published constraint information.

In a fourth representative embodiment, a method to subscribe to content that is associated with a content identifier is disclosed. The method comprises: publishing, by a subscriber, constraint information that corresponds to the content identifier of the content; sending, by the subscriber, a request for the content including the content identifier; and receiving, by the subscriber, the content in accordance with the published constraint information.

In a fifth representative embodiment, a rendezvous point (RP) is disclosed. The RP comprises: a transmit/receive unit configured to: obtain, from a subscriber, a content identifier associated with content, and obtain constraint information that is established in accordance with a constraint namespace and associated with at least one publisher of the content; and a processor communicatively coupled to the transmit/receive unit and configured to match the at least one publisher of the content to the subscriber of the content based on the obtained content identifier and the obtained constraint information.

In a sixth representative embodiment, a constraint server (CS) configured to manage constraints of a plurality of entities that are associated with a constraint namespace is disclosed. The CS comprises: a processor and a transmit/receive unit configured to: subscribe to one or more publications of constraint information provided by a respective one or respective ones of the entities; associate the constraint information provided by the respective one or ones of the entities and one or more content identifiers associated with the respective one or ones of the entities, as constraint namespace information; and publish to a rendezvous point the constraint namespace information.

In a seventh representative embodiment, a publisher configured to publish content that is associated with a content identifier is disclosed, The publisher comprises: a processor configured to publish constraint information that corresponds to the content identifier of the content; and a transmit/receive unit configured to receive a request for the content, wherein the processor and the transmit/receive unit are configured to publish the content for a subscriber in accordance with the published constraint information.

In an eighth representative embodiment, a subscriber configured to subscribe to content that is associated with a content identifier is disclosed. The subscriber comprises: a processor configured to publish constraint information that corresponds to the content identifier of the content; and a transmit/receive unit configured to send a request for the content, wherein the processor and the transmit/receive unit are configured to receive the content in accordance with the published constraint information.

In one or more representative embodiments including the first and fifth embodiments, the obtaining of the content identifier includes receiving a request for the content, the request including the content identifier.

One or more representative embodiments including the first and fifth embodiments, comprise establishing the first namespace, as a content namespace, associated with content identifiers; and establishing the second namespace, as a constraint namespace, which is independent of the content namespace.

In one or more representative embodiments including in the first and fifth embodiments, the matching of the at least one publisher of content to the subscriber of the content includes: matching a content identifier of the at least one publisher to a content identifier of the subscriber; and satisfying one or more rules using the constraint information associated with the at least one publisher and other constraint information associated with the subscriber.

In one or more representative embodiments including in the first and fifth embodiments, the matching of the at least one publisher of the content to the subscriber of the content includes matching based on any of: (1) location information; (2) territory and/or country information; (3) zone information; (4) identity information; (5) owner information; (6) privacy-related information; (7) QoE information; (8) a price constraint and/or (9) operational information associated with network operations.

In one or more representative embodiments including in the first and fifth embodiments, the obtaining of the constraint information includes subscribing, by the first entity to the constraint information stored in the second entity via a scope represented by a portion of a logical structure in the second entity based on the content identifiers that are maintained at the first entity.

In one or more representative embodiments including in the first and fifth embodiments, the obtaining of the constraint information associated with the at least one publisher of the content includes obtaining, from the second entity, first constraint information associated with the at least one publisher and second constraint information associated with the subscriber; and the matching of the at least one publisher of the content to the subscriber of the content is based on a match of the obtained content identifier and satisfaction of one or more rules using the obtained first and second constraint information.

One or more representative embodiments including the first and fifth embodiments comprise obtaining constraint information associated with the subscriber from a request of the subscriber along with the content identifier.

One or more representative embodiments including the first and fifth embodiments comprise sending the constraint information associated with the subscriber to the second entity.

In one or more representative embodiments including in the first and fifth embodiments, the first and second entities are encompassed in a single device.

One or more representative embodiments including the second and sixth embodiments comprise establishing a first namespace, as a content namespace, that is associated with content identifiers; and establishing the constraint namespace, as a second, independent namespace.

In one or more representative embodiments including in the second and sixth embodiments, the associating of the constraint information provided by the respective one or ones of the entities and the one or more content identifiers associated with the respective one or ones of the entities, as the constraint namespace information includes: establishing a logical structure which includes a plurality of levels; and storing, by the constraint server, the constraint information in a lowest level of the logical structure.

In one or more representative embodiments including in the second and sixth embodiments, the establishing of the logical structure includes: setting a highest level of the logical structure, as a root level node of the logical structure; and setting a first level of the logical structure with a plurality of first level nodes, each first level node being associated with the root level node of the logical structure.

In one or more representative embodiments including in the second and sixth embodiments, the establishing of the logical structure includes: setting a second level of the logical structure with a plurality of second level nodes, each second level node being associated with one of the first level nodes of the logical structure; and setting the lowest level of the logical structure with a plurality of third level nodes, each third level node being associated with one of the second level nodes of the logical structure.

One or more representative embodiments including the second and sixth embodiments comprise storing in one or more first level nodes of the logical structure respectively different publisher identifiers and/or subscriber identifiers.

One or more representative embodiments including the second and sixth embodiments comprise storing in a second level node associated with a respective one of the first level nodes a single content identifier associated with the content.

One or more representative embodiments including the second and sixth embodiments comprise storing in the third level node associated with a respective one of the second level nodes the constraint information associated with the single content identifier.

In one or more representative embodiments including in the third and seventh embodiments, the publishing of the content to the subscriber in accordance with the published constraint information includes publishing the content to the subscriber on condition that a constraint associated with the published constraint information corresponding to the content identifier is satisfied.

In one or more representative embodiments including in the third and seventh embodiments, the constraint information includes the constraint associated with any of: (1) location information of the publisher; (2) territory and/or country information of the publisher; (3) zone information of the publisher; (4) privacy-related information associated with handling of the content, subscriber information or publisher information; (5) QoE information associated with handling of the content for publication by the publisher; (6) a price constraint for charging of the subscriber on reception of the content by the subscriber; and/or (7) operational information associated with network operations.

In one or more representative embodiments including in the fourth and eighth embodiments, the receiving of the content in accordance with the published constraint information includes receiving the content on condition that a constraint associated with the published constraint information corresponding to the content identifier is satisfied.

In one or more representative embodiments including in the fourth and eighth embodiments, the constraint information includes the constraint associated with any of: (1) location information of the subscriber; (2) territory and/or country information of the subscriber; (3) zone information of the subscriber; (4) privacy-related information associated with handling of the content, subscriber information or publisher information; (5) QoE information associated with handling of the content by the subscriber; 6) a price constraint for charging of the subscriber on reception of the content by the subscriber and/or (7) operational information associated with network operations.

In one or more representative embodiments including in the first and fifth embodiments, the transmit/receive unit is configured to receive a request for the content, the request including the content identifier.

In one or more representative embodiments including in the first and fifth embodiments, a content namespace is associated with content identifiers; and the constraint namespace is independent of the content namespace.

In one or more representative embodiments including in the first and fifth embodiments, the processor is configured to match the at least one publisher to the subscriber on condition that a content identifier of the at least one publisher to a content identifier of the subscriber match and one or more rules regarding the constraint information associated with the at least one publisher and other constraint information associated with the subscriber are satisfied.

In one or more representative embodiments including in the first and fifth embodiments, the processor is configured to match the at least one publisher to the subscriber based on any of: (1) location information; (2) territory and/or country information; (3) zone information; (4) identity information; (5) owner information; (6) privacy-related information; (7) QoE information; (8) a price constraint; and/or (9) operational information.

In one or more representative embodiments including in the first and fifth embodiments, the processor is configured to subscribe to the constraint information in a constraint server via a scope represented by a portion of a logical structure in the constraint server based on the content identifiers that are maintained at the RP.

In one or more representative embodiments including in the first and fifth embodiments, the transmit/receive unit is configured to obtain, from a second entity, the constraint information associated with the at least one publisher, as first constraint information, and further constraint information associated with the subscriber, as second constraint information; and the processor is configured to match the at least one publisher of the content to the subscriber of the content based on a match of the obtained content identifier and satisfaction of one or more rules using the obtained first constraint information and second constraint information.

In one or more representative embodiments including in the first and fifth embodiments, the transmit/receive unit is configured to receive constraint information associated with the subscriber from a request of the subscriber along with the content identifier.

In one or more representative embodiments including in the first and fifth embodiments, the transmit/receive unit is configured to send the constraint information associated with the subscriber to a second entity.

In one or more representative embodiments including in the first and fifth embodiments, the RP manages constraints of a plurality of entities using a constraint namespace, the RP further comprises: a constraint module configured to: subscribe to one or more publications of the constraint information provided by a respective one or respective ones of the entities, associate the constraint information provided by the respective one or ones of the entities and one or more content identifiers associated with the respective one or ones of the entities, as constraint namespace information, and publish the constraint namespace information; and a matching module configured to: receive the constraint namespace information published by the constraint module, and match the at least one publisher of the content to the subscriber of the content based on the obtained content identifier and the received constraint namespace information published by the constraint module.

In one or more representative embodiments including in the second and sixth embodiments, a first namespace is established, as a content namespace, and is associated with content identifiers; and the constraint namespace is established, as a second, independent namespace.

In one or more representative embodiments including in the second and sixth embodiments, the processor is configured to: establish in a memory a logical structure which includes a plurality of levels; and store in the memory the constraint information in a lowest level of the logical structure.

In one or more representative embodiments including in the second and sixth embodiments, the processor is configured to: set a highest level of the logical structure, as a root level node of the logical structure; and set a first level of the logical structure with a plurality of first level nodes, each first level node being associated with the root level node of the logical structure.

In one or more representative embodiments including in the second and sixth embodiments, the processor is configured to: set a second level of the logical structure with a plurality of second level nodes, each second level node being associated with one of the first level nodes of the logical structure; and set a lowest level of the logical structure with a plurality of third level nodes, each third level node being associated with one of the second level nodes of the logical structure.

In one or more representative embodiments including in the second and sixth embodiments, the memory is configured to store in one or more first level nodes of the logical structure respectively different publisher identifiers and/or subscriber identifiers.

In one or more representative embodiments including in the second and sixth embodiments, the memory is configured to store in a second level node that is associated with a respective one of the first level nodes a single content identifier associated with the content.

In one or more representative embodiments including in the second and sixth embodiments, the memory is configured to store in one third level node associated with a respective one of the second nodes the constraint information associated with the single content identifier.

In one or more representative embodiments including in the third and seventh embodiments, the processor and the transmit/receive unit are configured to publish the content on condition that a constraint associated with the published constraint information corresponding to the content identifier is satisfied.

In one or more representative embodiments including in the third and seventh embodiments, the constraint information includes the constraint associated with any of: (1) location information of the publisher; (2) territory and/or country information of the publisher; (3) zone information of the publisher; (4) privacy-related information associated with the content, the publisher and/or the subscriber; (5) QoE information associated with handling of the content for publication by the publisher; (6) a price constraint for changing of the subscriber on reception of the content by the subscriber; and/or (7) operational information associated with network operations.

In one or more representative embodiments including in the fourth and eighth embodiments, the constraint information includes the constraint associated with any of: (1) location information of the subscriber; (2) territory and/or country information of the subscriber; (3) zone information of the subscriber; (4) privacy-related information of the content, the publisher and/or the subscriber; (5) QoE information associated with handling of the content by the subscriber; (6) a price constraint for charging of the subscriber on reception of the content by the subscriber; and/or (7) operational information associated with network operations.

1. A method of matching at least one publisher of content to a subscriber of the content, the method comprising:
obtaining, by a first entity from the subscriber, a content identifier associated with the content, the content identifier being established in accordance with a first namespace;
separately obtaining, by the first entity from a second entity, constraint information that is established in accordance with a second namespace and associated with the at least one publisher of the content; and
matching the at least one publisher of the content to the subscriber of the content based on the obtained content identifier and the obtained constraint information.

2. The method of claim 1, wherein the obtaining of the content identifier includes receiving a request for the content, the request including the content identifier.

3. The method of claim 1, further comprising:
establishing the first namespace, as a content namespace, associated with content identifiers; and
establishing the second namespace, as a constraint namespace, which is independent of the content namespace.

4. The method of claim 1, wherein the matching of the at least one publisher of content to the subscriber of the content includes:
matching a content identifier of the at least one publisher to a content identifier of the subscriber; and
satisfying one or more rules using the constraint information associated with the at least one publisher and other constraint information associated with the subscriber.

5. The method of claim 1, wherein the matching of the at least one publisher of the content to the subscriber of the content includes matching based on any of: (1) location information; (2) territory and/or country information; (3) zone information; (4) identity information; (5) owner information; (6) privacy-related information; (7) QoE information; (8) a price constraint and/or (9) operational information associated with network operations.

6. The method of claim 1, wherein the separately obtaining of the constraint information includes subscribing, by the first entity to the constraint information stored in the second entity via a scope represented by a portion of a logical structure in the second entity based on the content identifiers that are maintained at the first entity.

7. The method of claim 1, wherein:
the separately obtaining of the constraint information associated with the at least one publisher of the content includes obtaining, from the second entity, first constraint information associated with the at least one publisher and second constraint information associated with the subscriber; and
the matching of the at least one publisher of the content to the subscriber of the content is based on a match of the obtained content identifier and satisfaction of one or more rules using the obtained first and second constraint information.

8-24. (canceled)

25. A rendezvous point (RP), comprising:
a transmit/receive unit configured to:
obtain, from a subscriber, a content identifier associated with content, and
separately obtain constraint information that is established in accordance with a constraint namespace and associated with at least one publisher of the content; and
a processor communicatively coupled to the transmit/receive unit and configured to match the at least one publisher of the content to the subscriber of the content based on the obtained content identifier and the separately obtained constraint information.

26. The RP of claim 25, wherein the transmit/receive unit is configured to receive a request for the content, the request including the content identifier.

27. The RP of claim 25, wherein:
a content namespace is associated with content identifiers; and
the constraint namespace is independent of the content namespace.

28. The RP of claim 25, wherein the processor is configured to match the at least one publisher to the subscriber on condition that a content identifier of the at least one publisher to a content identifier of the subscriber match and one or more rules regarding the constraint information associated with the at least one publisher and other constraint information associated with the subscriber are satisfied.

29. The RP of claim 25, wherein the processor is configured to match the at least one publisher to the subscriber based on any of: (1) location information; (2) territory and/or country information; (3) zone information; (4) identity information; (5) owner information; (6) privacy-related information; (7) QoE information; (8) a price constraint; and/or (9) operational information.

30. The RP of claim 25, wherein the processor is configured to subscribe to the constraint information in a constraint server via a scope represented by a portion of a logical structure in the constraint server based on the content identifiers that are maintained at the RP.

31. The RP of claim 25, wherein:
the transmit/receive unit is configured to separately obtain, from a second entity, the constraint information associated with the at least one publisher, as first constraint information, and further constraint information associated with the subscriber, as second constraint information; and
the processor is configured to match the at least one publisher of the content to the subscriber of the content based on a match of the obtained content identifier and satisfaction of one or more rules using the obtained first constraint information and second constraint information.

32-33. (canceled)

34. The RP of claim 25, wherein the RP manages constraints of a plurality of entities using a constraint namespace, the RP further comprising:
a constraint module configured to:
subscribe to one or more publications of the constraint information provided by a respective one or respective ones of the entities,
associate the constraint information provided by the respective one or ones of the entities and one or more content identifiers associated with the respective one or ones of the entities, as constraint namespace information, and
publish the constraint namespace information; and
a matching module configured to:
receive the constraint namespace information published by the constraint module, and
match the at least one publisher of the content to the subscriber of the content based on the obtained content identifier and the received constraint namespace information published by the constraint module.

35. A constraint server (CS) configured to manage constraints of a plurality of entities that are associated with a constraint namespace, comprising:
a processor and a transmit/receive unit configured to:
subscribe to one or more publications of constraint information provided by a respective one or respective ones of the entities;
associate the constraint information provided by the respective one or ones of the entities and one or more content identifiers associated with the respective one or ones of the entities, as constraint namespace information; and
publish to a rendezvous point the constraint namespace information.

36. The CS of claim 35, wherein:
a first namespace is established, as a content namespace, and is associated with content identifiers; and
the constraint namespace is established, as a second, independent namespace.

37. The CS of claim 35, wherein the processor is configured to:
establish in a memory a logical structure which includes a plurality of levels; and
store in the memory the constraint information in a lowest level of the logical structure.

38. The CS of claim 37, wherein the processor is configured to:
set a highest level of the logical structure, as a root level node of the logical structure;
set a first level of the logical structure with a plurality of first level nodes, each first level node being associated with the root level node of the logical structure;
set a second level of the logical structure with a plurality of second level nodes, each second level node being associated with one of the first level nodes of the logical structure; and
set a lowest level of the logical structure with a plurality of third level nodes, each third level node being associated with one of the second level nodes of the logical structure.

39. (canceled)

40. The CS of claim 38, wherein the memory is configured to store:
in one or more first level nodes of the logical structure respectively different publisher identifiers and/or subscriber identifiers;
in a second level node that is associated with a respective one of the first level nodes a single content identifier associated with the content; and
in one third level node associated with a respective one of the second nodes the constraint information associated with the single content identifier.

41-47. (canceled)
